(19) United States
(12) Patent Application Publication
(10) Pub. No.: US 2025/0371588 A1
(43) Pub. Date: Dec. 4, 2025

(54) Modular System for Coordinated Repair Estimation, Scheduling, and Service Delivery in Automotive Repair Networks

(71) Applicant: Rohan Patel, Bensalem, PA (US)

(72) Inventor: Rohan Patel, Bensalem, PA (US)

(21) Appl. No.: 19/218,498

(22) Filed: May 26, 2025

Related U.S. Application Data
(60) Provisional application No. 63/652,277, filed on May 28, 2024.

(51) Int. Cl. G06Q 30/0283; G06Q 10/20

(52) U.S. Cl. CPC G06Q 30/0284; G06Q 10/20

(57) ABSTRACT

An interactive repair estimation system presents additional or related repair operations to the customer during estimate creation. These add-on services are grouped with the primary repair task based on procedural overlap, shared labor access points, or standard industry practices. The system dynamically adjusts pricing to reflect bundled efficiencies and provides visual or textual justifications for each recommendation. Customers can selectively accept or decline add-on items, while certain logic dependencies ensure that related operations are offered only when relevant. This approach improves transparency, increases repair order value, and reduces repeat visits.

### PRIORITY

claims priority of provisional application 63/652,277 filed on May 28, 2024.

### BACKGROUND

Independent automotive repair shops, mobile technicians, and residential service providers face significant challenges in delivering streamlined and transparent vehicle service experiences. The absence of integrated scheduling tools, centralized marketplaces, predictive diagnostics, dynamic estimation systems, and on-demand parts sourcing often results in fragmented workflows, inefficiencies, and loss of customer trust. There exists a need for a modular platform that coordinates these core functions while supporting flexible implementation for service providers of all sizes.

### SUMMARY OF THE INVENTION

The present invention provides a multi-featured platform for managing vehicle service delivery, designed specifically for independent and mobile automotive repair networks. The system integrates several innovative modules, each capable of operating independently or in conjunction with one or more other modules. The overall platform may be deployed in full or partially, depending on the needs of the repair facility, the customer, or the geographic and logistical constraints of service delivery.

In one aspect of the invention, the system provides an interactive bundled repair estimation tool that presents multiple related repair operations together and displays a total cost reflecting procedural overlap, such as reduced labor or part access redundancy. These operations may involve labor alone, part replacement, or a combination thereof. This feature allows customers to make informed decisions about optional services while enabling service providers to increase repair efficiency and ticket value without coercive up selling.

In another aspect, the system includes a component health monitoring engine that predicts part condition based on time elapsed and mileage driven since the last service. By referencing prior technician input or repair records, the system calculates a predicted wear percentage and alerts service providers when components approach service thresholds. This enables preventative care workflows, reduces unnecessary inspections, and reinforces customer trust.

In a further aspect, the invention provides a shared garage discovery and scheduling system. Independent service providers can list their service menus, credentials, brand specialties, and appointment slots through a centralized platform. Customers may filter results by distance, availability, or vehicle-specific criteria, and can book appointments directly through the platform. Service providers may either link their existing calendar tools or utilize a native scheduler provided by the system.

In another aspect, the system integrates parts sourcing from public online marketplaces. Upon generation of a repair estimate, the system may retrieve compatible parts from sources such as Amazon, eBay, or Rock Auto, and present ranked results based on proximity, seller reputation, cost, and/or delivery speed. This feature enables real-time pricing visibility and provides flexibility in part selection without locking technicians into proprietary vendors. The system also can be designed where the repair personnel shares links to compatible parts to the customers to be purchased and brought back with the vehicle for repair by the customer.

Additionally, the system facilitates temporary rental of residential garage spaces for vehicle service operations. Customers may book garage spaces near their location, and mobile technicians may perform work in a zoning-compliant manner by linking legal occupancy of the space to the customer during the time of repair. This feature expands available repair locations and empowers technicians without access to commercial repair bays.

Each module described above may be implemented as part of a unified platform or as a standalone feature. Multiple configurations and integration models are possible. The modular design allows for seamless scaling and incremental adoption, and each feature disclosed herein may be claimed independently in this or related applications, or in any combination without departing from the scope of the invention.

### BRIEF DESCRIPTION OF THE DRAWINGS

FIG. 1 illustrates a technician interface for initiating a vehicle inspection report, displaying projected wear percentages and allowing manual override and repair estimate generation.

FIG. 2 shows a customer-facing estimate interface where related repair operations are grouped and bundled pricing is dynamically updated based on selection.

FIG. 3 depicts the shared garage discovery and scheduling interface, allowing customers to search for garages based on location, availability, and specialization.

FIG. 4 presents the integrated parts sourcing module that filters listings by drivetrain, brake type, and trim-level compatibility, and displays vendor options with delivery timelines.

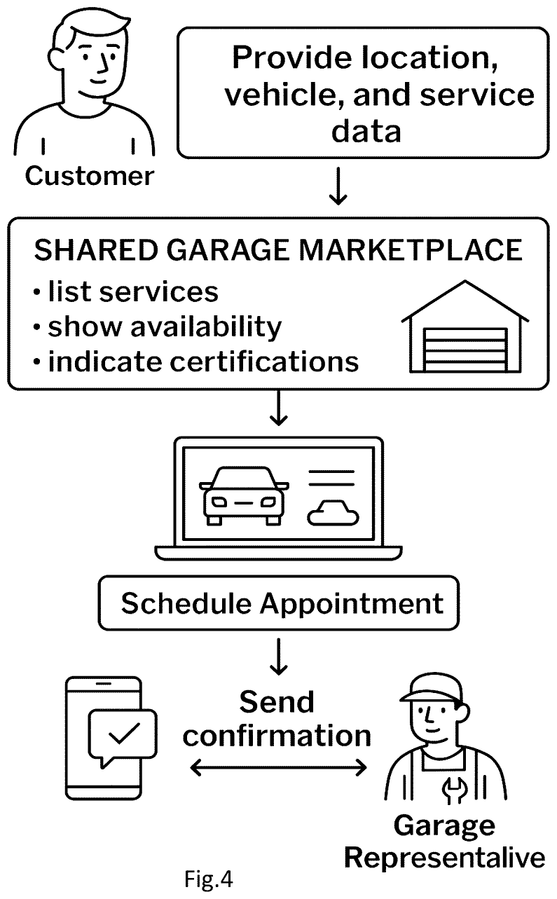

FIG. 5 illustrates the garage access coordination module where a residential garage is temporarily leased by a customer, enabling zoning-compliant repair work by a mobile technician. An example of the parts sourcing interface is shown in FIG. 4, where filtered vendor listings are displayed with vehicle-specific configuration options.

### DETAILED DESCRIPTION

In one embodiment, the system provides a shared online platform that allows unaffiliated, independently operated automotive repair facilities to publish service availability and receive customer bookings through a centralized digital interface. This marketplace acts as a discovery layer for vehicle owners seeking qualified repair professionals within a specified region, specialty, or vehicle brand expertise.

Each participating garage or technician may register a service profile containing one or more of the following elements:
Name, location, and contact information
Hourly labor rate(s), which may vary by brand or service category
List of available services or repair categories
Certifications held by the technician or facility (e. G., ASE, OEM)
Brand specialization (e. G., “BMW master tech” or “Toyota only”)
Calendar availability (either integrated from external systems or natively managed)

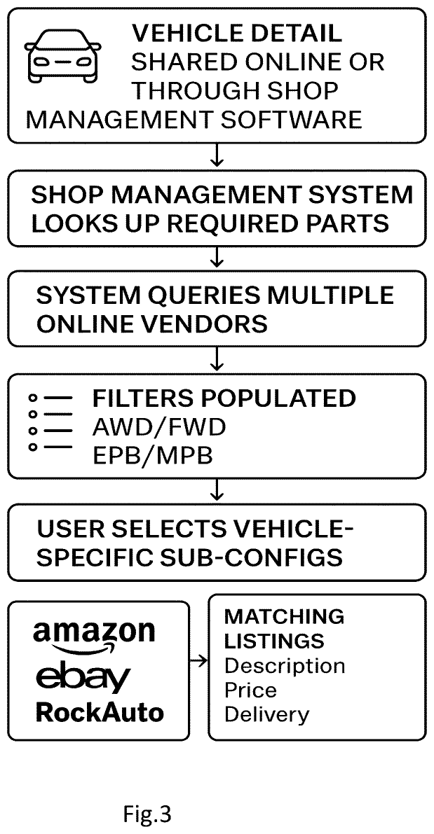

The system enables customers to search, browse, and filter these listings through a user-facing discovery interface, shown in FIG. 3, which may include inputs such as:
Vehicle year, make, and model
ZIP code or geolocation
Desired repair category (e. G., brakes, suspension, diagnostics)
Technician rating or experience tags
Available appointment times

In one embodiment, the system supports real-time appointment scheduling by either:
Linking with an external calendar or shop management software used by the garage (e. G., ShopMonkey, Tekmetric), or

Providing a native scheduling tool that allows participating providers to set business hours, blackout dates, technician availability, and appointment duration by service type.

Each appointment request includes structured metadata, including the customer's vehicle details, selected service type, and preferred time slot. Upon confirmation, the system may send notifications to both the garage and the customer via email, SMS, app notification, or any other communication channel. The system also can have overlapping time slow availability and/or restricted time slots (for lunch time or end of the day) if a selected repair estimated time may be longer than end of availability slot.

In some configurations, the system may also support multi-slot logic, where the customer sees overlapping windows based on technician availability, service duration, or multi-bay shop logistics. Shops may choose to enable automatic approval for certain repair types or require manual review before appointment confirmation.

The marketplace platform may be deployed as a standalone web portal, embedded widget for independent garage websites, or mobile app for technician, repair personnel, and/or customer to monitor through an app or any other form of interconnected system. It may further be integrated with other modules of the invention, including:

The predictive component monitoring module, which may suggest recommended service intervals and prompt customers to book based on projected part degradation

The bundled repair estimate module, allowing shops to pre-list bundled services and discount logic within their public service menus

The garage rental module, offering booking options for residential service spaces when a commercial bay is unavailable

This scheduling and discovery infrastructure creates a scalable, decentralized alternative to traditional dealership service networks and enables small and mid-size garages to benefit from platform-level customer acquisition, digital tools, and automation without surrendering operational control.

In another embodiment, the system includes a predictive component wear tracking module that enables service providers, or an mobile app or web app for customer to monitor and forecast the health of vehicle components over time. Each serviceable component-such as an air filter, cabin filter, brake pad, tire, or belt—is associated with a health status value, which may be expressed as a percentage (e. G., 100% for new or replaced, 60% for moderately used, etc.), a tiered condition scale (e. G., good, fair, poor), or another quantifiable degradation metric.

When a vehicle is serviced, a technician or system may input the current health status of each inspected component. This value becomes the baseline for future calculations. The system stores the service date and odometer reading at the time of entry, and uses the vehicle's mileage and time elapsed since that entry to estimate a current projected health percentage during subsequent visits.

For example, if an air filter was marked as “70% healthy” during a prior visit, and the vehicle has since been driven 6,000 miles over four months, the system may automatically adjust the projected health value to 60%, using a degradation model based on average wear rates. This predicted value is surfaced to the technician during the current visit when preparing a digital health check report.

To support accuracy and flexibility, the system provides the technician with the ability to override the calculated health value based on current visual or physical inspection. If, for instance, the technician or a shop personnel finds the component in better or worse condition than projected, they may enter a revised value, which resets the decay model for future visits.

In some embodiments, components falling below a configurable health threshold (e. G., 30%) may trigger visual alerts or any other form of alerts, recommended action flags, or pre-filled estimate entries. These warnings may be surfaced internally to the technician or externally to the customer, through but not limited to mobile app or web app or any other method of sending alerts to the cell phone or personal electronic device, depending on configuration. Historical wear data may also be visualized in a trendline format, enabling both parties to assess how component condition has changed over time.

This component wear prediction logic may be used independently, or integrated with the bundled repair estimator, the inspection report interface, the scheduling system (e. G., flagging overdue replacements), or parts sourcing logic (e. G., auto-loading needed items into the estimate when wear falls below thresholds).

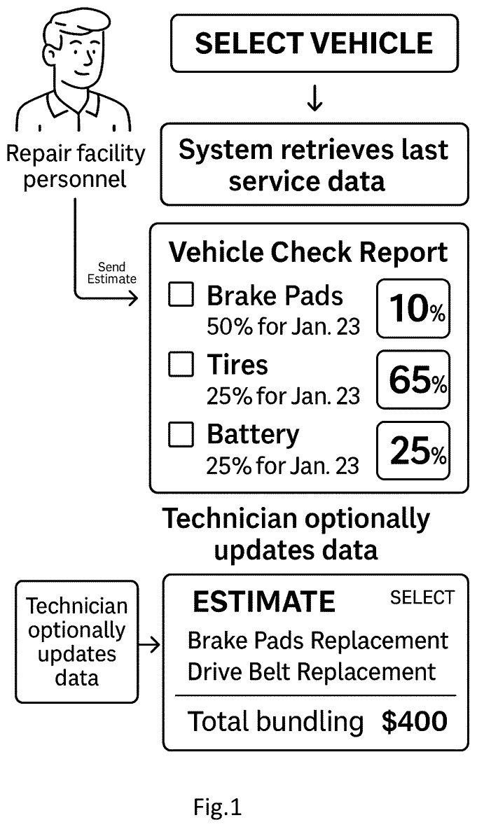

In one embodiment, illustrated in FIG. 1, the system presents a technician-facing health check interface that displays both the last recorded condition and the system-calculated current projected condition for each serviceable component of the vehicle. The projected condition is calculated using one or more degradation models that factor in elapsed mileage and time since the last inspection.

Each component entry within the interface includes:

A label identifying the component (e. G., “Cabin Air Filter”)

The last technician-entered value (e. G., 70% at 12,000 miles, 3 months ago)

The current projected wear value (e. G., 60% based on average decay)

A manual override field allowing the technician to input a new value after direct inspection (e. G., entering 80% if the component appears newer than expected)

The interface may further include:

Visual trend indicators (e. G., a bar chart or degradation curve)

A flag or icon if projected wear drops below a configurable threshold (e. G., <30%)

An “Add to Estimate” button to automatically generate a repair line item if replacement is warranted

The system saves the updated condition value, resets the wear model baseline, and optionally logs any override as a manual entry with timestamp and technician ID for auditability.

As shown in FIG. 1, this interface can be used as part of a technician's regular health check workflow or integrated into the estimate-building interface. The health monitoring feature may function independently of other modules or in conjunction with:

The bundled estimate logic (e. G., automatically suggesting spark plugs when valve cover replacement is flagged and degradation is detected)

The scheduling module (e. G., notifying customers of predicted upcoming needs)

The parts sourcing module (e. G., preloading required parts into an estimate based on projected wear)

The ability to both project and override component health creates a hybrid human-AI decision support tool that improves technician efficiency and customer trust.

In one embodiment, the system includes an integrated parts sourcing module configured to identify and retrieve compatible replacement parts from one or more public online marketplaces, based on the repair operations selected in a vehicle estimate.

When a repair operation is added—either directly or through the bundled repair suggestion logic—the system determines whether one or more replacement parts are required. The relevant part types are inferred from a parts database, a technician's prior input, or a service-to-parts mapping table that links each repair operation to its required components.

Upon identifying the part category, the system performs a query to external sources such as Amazon, RockAuto, or eBay to retrieve candidate listings. These queries may be conducted via marketplace APIs or, where APIs are not available, through structured catalog scraping or using AI to navigate through an online website/s, marketplaces etc. Retrieved part data may include:
Part brand and type
Vehicle fitment details
Price
Seller information and review history
Shipping options and estimated delivery time
Dynamic Compatibility Filtering Based on Vehicle Sub-options

In some embodiments, the system performs intelligent analysis of all returned listings and automatically identifies key sub-features that influence part compatibility. For example, if listings differ by drivetrain (e. G., AWD vs. FWD), or brake system type (e. G., Electric Parking Brake [EPB] vs. Manual Parking Brake [MPB]), the system will recognize these dimensions and dynamically generate filtering inputs at the top of the parts interface.

The user is then prompted to confirm these configuration attributes by selecting from a limited set of options, such as:
AWD or FWD
EPB or MPB
VIN-based trim levels or axle ratios
Wheel size, engine variant, or other differentiators found in the fitment data

Once the user makes a selection (e. G., AWD+EPB), the system automatically filters out all incompatible listings and displays only the parts that match the selected configuration. This removes the burden from the technician or customer of reading and interpreting every listing line-by-line and ensures only properly fitting parts are presented, even when marketplace listings contain fragmented or partially labeled data. This novel filtration method can also be applied to look up parts on auto parts websites such as autozone etc. And/or a shop management system where most common differentiator for part compatibility is auto populated for the user to select one time and filter available parts for the vehicle.

### Seller Quality Control and Review Analysis

In addition to compatibility filtering, the system also performs automated seller screening and content evaluation. Certain sellers may be:
Excluded entirely based on historical data (e. G., low feedback rating, refund history, repeated shipping delays)
Flagged for caution based on current reviews analyzed in real-time using AI

The system may apply natural language processing (NLP) models to parse and interpret recent buyer reviews. If patterns emerge indicating part mismatch, poor packaging, counterfeit concerns, or delivery reliability issues, the listing may be hidden or deprioritized. This seller filtering logic helps maintain quote quality and reduces technician frustration or part return rates.

Selection and Integration into Estimate

Once a compatible and trusted part is selected-either manually by the technician or auto-selected by the system-its details are merged directly into the repair estimate. In some configurations:

The estimate total updates in real time as different parts are toggled

Technicians can override suggestions and add custom parts

Multiple components can be bundled (e. G., pad and rotor kits) when offered by a seller/sellers (one part from one seller and another part from another seller)

Parts sourcing may further integrate with:
Appointment scheduling, to warn if part lead time conflicts with booked times
Inspection data, to auto-suggest replacement based on predicted wear
Bundled repair operations, ensuring every part required for every accepted repair is sourced in a compatible format

This system may function independently or in conjunction with other modules in the platform. It enhances trust, reduces turnaround time, and gives small or mobile shops access to advanced parts logistics without requiring local inventory.

In one embodiment, the system provides a garage access coordination module that enables customers to temporarily rent private residential garage spaces for the purpose of conducting vehicle repair operations. This feature is particularly useful for mobile technicians who lack access to commercial bays or for customers seeking local, flexible service options without traveling to traditional repair shops.

The module facilitates the discovery, reservation, legal occupancy, and operational support of residential garage spaces on a per-job or hourly basis. It is intended to operate in compliance with local zoning rules by structuring the garage use in such a way that the customer—not the technician—is recognized as the temporary lawful occupant of the space during the time of repair.

### Listing and Discovery of Garage Spaces

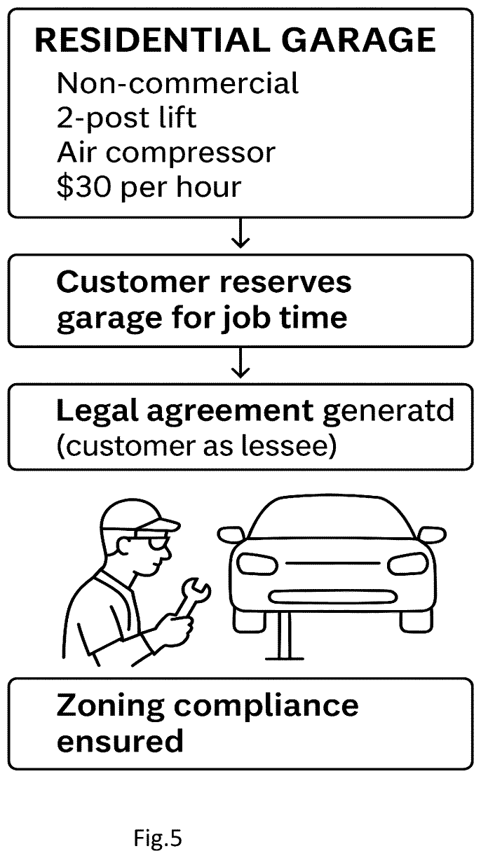

Residential garage owners may register with the platform and create listings that include:
Address or general location
Physical characteristics (e. G., size, ceiling height, presence of lift or flat surface)
Electrical access (e. G., 110V, 220V)
Photos or videos of the space
Availability windows and blackout dates
Pricing per hour or per appointment
Optional features (e. G., restroom access, security cameras)
Customers seeking service through the platform can search for available garages within a given preferred proximity or regions from their location or desired technician, as illustrated in FIG. 5.
Garage listings may be filtered by:
Availability at specific times or dates
Minimum required garage features (e. G., vehicle clearance, driveway access)
Customer or technician ratings
Proximity to service address or technician's current location
Booking and Legal Access Workflow

Once a garage is selected, the customer may reserve the space for the date and time that matches their service appointment. The system automatically generates a temporary rental agreement that:
Identifies the customer as the lessee for the scheduled window
Describes permitted use of the garage (vehicle service only)
May include liability waivers or insurance disclosures
Optionally includes rules set by the homeowner (e. G., no fluid disposal on site)

This agreement is stored in the system and made available to both parties, establishing that the garage is under the legal control of the customer during the service period. As a result, the mobile technician is considered to be performing the work on-site for the customer, not as a business operating from a residential property—satisfying many local zoning regulations.

Coordination with Technicians and Other Modules

Once booked, the garage rental system may notify the technician, who can then confirm arrival plans and prepare for the job. The platform may also support:
Secure PIN entry or garage code exchange
Access logs for both customer and technician
In-app chat or checklist sharing between customer, garage owner, and technician Garage rentals may be integrated with other modules, such as:

The repair scheduling platform, ensuring garage and technician availability align

The estimate generation interface, enabling garage fees to be included in the total cost

The health monitoring or parts logistics systems, allowing full job execution from diagnosis to completion within the temporary service location

The garage rental module enables hyper-local, legally compliant repair service by allowing independent technicians to meet customers where they are, without owning a permanent facility. It also provides passive income to homeowners (mostly technicians' owned) with unused space. The system also can have a filter where available garages/technician to repair are populated by brand/model/type of service in combination with proximity from customer's geographical location

In one embodiment, the system includes a dynamic repair estimation module configured to present bundled or related repair operations as a unified interactive estimate. The goal is to increase transparency, reduce labor redundancy, and allow customers to make cost-effective decisions based on operational overlap, shared access points, or complementary service logic.

### a Primary and Add-on Operation Grouping

When a technician or system selects a primary repair operation (e. G., valve cover gasket replacement), the system automatically identifies one or more additional repair operations that are frequently performed in conjunction due to shared procedural steps or physical access (e. G., spark plug replacement). These related operations are displayed beneath or near the primary operation within the estimate interface as grouped, optionally dependent add-ons.

The system may rely on a predefined database of bundled service pairings, labor time optimization rules, or historical co-occurrence data across previously generated estimates. The pairing logic is not limited to labor savings but may also reflect:
Tool setup or teardown overlap
Parts already being removed for primary operation
Access area redundancy (e. G., wheel off, cover plate removed)

### Dynamic Cost Adjustment

When the primary and add-on operations are selected together, the system displays a combined price that reflects reduced total cost compared to performing the operations separately. This reduction may be due to shared labor time, reduced service overhead, or part bundle pricing. The estimated cost may include: Parts, Labor, Disposal fees, Garage rental (if applicable),

### Diagnostic or Inspection Surcharges

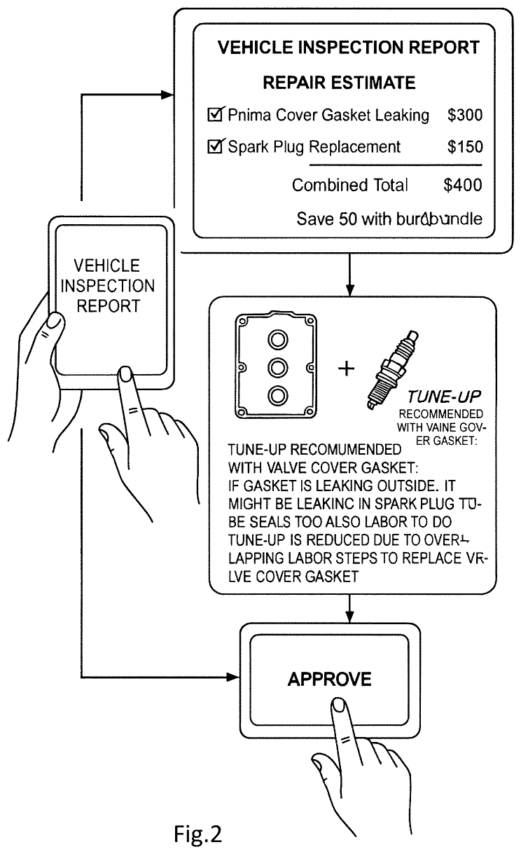

The total updates in real-time as the customer selects or declines each operation, as illustrated in FIG. 2. If the customer deselects the primary repair, the system may:
Automatically hide dependent add-on operations
Reset pricing for standalone services
Warn the customer if a dependent add-on cannot be performed alone (e. G., cannot replace spark plugs without removing valve cover)
Visual Grouping and Explanatory Aids

To aid customer understanding and support transparency, the system may present grouped repairs with:
Labels such as “Suggested Add-On,” “Save 0.8 hrs if done now,” or “Bundle & Save”
Expandable tooltips or video explainers showing why the services are linked
Graphical indicators (e. G., brackets, icons) connecting grouped items

These aids may also appear in printed or PDF versions of the estimate, not just the interactive UI.

### Technician and System Collaboration

In some embodiments, the system may auto-suggest bundles based on service logic, but technicians retain control to:
Approve or remove certain add-on suggestions
Mark services as mandatory or optional
Adjust pricing when exceptions apply

Add-on logic may be influenced by customer history, vehicle make/model, or real-time inspection findings. For instance, a technician replacing a timing cover may also suggest water pump replacement if both has overlapping steps. The repair operations also can have no overlapping steps but are set to be recommended together. Recommendation also can be based on industry standard for ex. Recommending alignment with tire replacement, or at certain time interval or at certain mileage intervals.

### Independent and Integrated Operation

The bundled repair estimate module may be used:
As a standalone estimation tool
Integrated into the marketplace scheduling system
Combined with parts lookup, so that bundled operations also trigger compatible part bundles Paired with predictive health monitoring, where degraded components are auto-suggested as add-ons to confirmed operations

This bundled estimation process increases repair order quality, supports full-scope repairs during a single visit, and minimizes repeat appointments due to missed service dependencies.

In some embodiments, the technician performing the repair may also be the owner or resident of the residential property where the space being rented to the customer whose vehicle is to be performed legally to bypass zoning laws. In such cases, the system enables zoning compliance by structuring the transaction such that the customer becomes the temporary legal occupant of the garage through a time-limited rental agreement. This arrangement allows the technician to conduct repair work in a residential setting without violating local ordinances that prohibit commercial automotive work on customer vehicles at residential properties. Furthermore, when the technician owns the facility, any liability associated with bodily injury arising from conditions of the property itself—such as slips, falls, or equipment hazards—may be borne by the technician directly being owner of the premises too, thereby reducing or eliminating the customer's exposure to liability under separate insurance policies. Responsibility for damage related to the vehicle remains with the technician's business or personal coverage or an insurance purchased through the marketplace like structure like airbnb that helps rent out garage to a customer for a short terms.

In some embodiments, the bundled estimation logic may be manually created or adjusted by technicians to reflect specific procedural knowledge or vehicle-specific labor overlaps not fully captured by automated rules. For example, when a timing belt replacement is selected, the technician may manually add the water pump and tensioner as bundled items if they are located behind the same cover, even if this pairing is not pre-defined in the system database. This flexibility allows repair facilities to avoid redundant labor charges, encourage same-visit efficiency, and reduce the likelihood of repeat appointments for otherwise predictable repairs. The system may store these technician-defined bundle rules for future reuse, or allow administrators to approve and share them across multiple users within the same shop.

In some configurations, the system may associate each component type with a degradation curve based on real-world fleet data or manufacturer recommendations. These decay models may differ based on vehicle class, usage profile, or regional climate. For example, brake pad wear may accelerate in urban stop-and-go traffic, while air filter degradation may be higher in dusty environments. The system may refine its predictions over time by comparing projected versus actual condition values recorded during follow-up inspections. This learning feedback loop allows the engine to become more accurate for each specific vehicle or usage pattern. Additionally, the system may notify customers proactively based on predicted decline trajectories, reducing unplanned breakdowns and enabling predictive maintenance scheduling.

In some configurations, the scheduling system may also include automated conflict detection across multiple resources such as technician availability, garage occupancy, and part delivery timelines. When a customer attempts to book a time slot, the system may cross-reference expected part arrival dates or previously booked operations that require shared tooling or bays. This ensures that bookings are only accepted when all required elements are likely to be available, minimizing delays or rebooking. The system may optionally offer intelligent time slot suggestions based on predicted readiness and may provide customers with visual indicators such as “parts arriving,” “technician on-site,” or “garage ready” for enhanced transparency.

In some embodiments, the parts sourcing module may support technician-specific or garage-specific preferences, such as preferred brands, vendor exclusions, or markup rules. The system may automatically prioritize listings from preferred suppliers or filter out sellers based on shop-defined rules (c. G., no refurbished parts, only local delivery, etc.). Additionally, when a selected part is not available, the system may display equivalent alternatives or trigger automated backorder notifications with estimated fulfillment dates. This intelligent sourcing logic helps technicians maintain quality standards, reduce customer wait times, and optimize procurement efficiency.

1. An interactive system for presenting a bundled vehicle repair estimate to a customer, comprising:
(a) a user interface configured to display a first repair operation associated with a vehicle, along with an option for the customer to approve or decline the first repair operation;
(b) the user interface further configured to display at least a second repair operation associated with the same vehicle, wherein the availability of the second repair operation for customer approval is optionally dependent on the selection of at least the first repair operation;
(c) a dynamic estimate calculation configured to present a reduced total service cost when both the first and second repair operations are selected together, compared to selecting each operation individually; and
(d) a selection interface configured to allow the customer to approve or decline available repair operations and to view an updated total repair estimate based on the customer's selections.

2. The system of claim 1, wherein at least the second repair operation is visually grouped beneath the first repair operation within the user interface, indicating its relationship as a dependent add-on.

3. The system of claim 1, wherein the estimated labor cost savings is displayed as a savings label or price adjustment notice or a visual indicator on the interactive system.

4. The system of claim 1, wherein the updated total repair estimate is recalculated and displayed in real time as the customer selects or deselects repair operations.

5. The system of claim 1, wherein the second repair operation is presented as an optional add-on labeled with a recommendation tag based on compatibility or shared labor procedures with the first repair operation.

6. The system of claim 1, wherein a predefined set of bundled repair operation pairs is maintained and referenced to determine labor optimization opportunities.

7. The system of claim 1, wherein the total estimated cost includes both parts and labor and is updated to reflect bundled pricing when multiple repair operations are selected together.

8. The system of claim 1, wherein the user interface includes a tooltip, icon, or expandable explanation indicating the reason for the labor savings when multiple repair operations are selected.

9. The system of claim 1, wherein the second repair operation becomes unavailable for selection if the first repair operation is declined.

10. The system of claim 1, wherein at least the second repair operation to be illustrated on the interactive system is confirmed by a personnel associated with the service repair facility.

11. The system of claim 1, wherein the vehicle inspection report is linked to the interactive system is linked to the vehicle inspection report of the same vehicle.

12. The system of claim 11, wherein the technician suggests or selects the second repair operation along with the first repair operation.

13. The system of claim 1, wherein the interactive system wherein a visual or a verbal or a video or a picture illustrates the suggested repair part or to help share information on why repair is recommended or require.

14. A system associated with generating and presenting a bundled repair estimate to a customer, comprising:
(a) an interface configured to enable a user affiliated with a service facility to approve, decline, suggest, or select one or more repair operations prior to their inclusion in a customer-facing estimate;
(b) an estimate generation process configured to produce a repair estimate that includes approved repair operations and presents a combined cost reflecting potential service bundling; and
(c) a customer interface configured to display the estimate, allow selection or de-selection of the presented repair operations, and dynamically reflect changes to the total cost based on the customer's selections.

15. The system of claim 14, wherein the interface is configured to allow the user to visually group dependent repair operations beneath their associated primary operations before inclusion in the customer-facing estimate.

16. The system of claim 14, wherein the interface enables the user to assign recommendation tags to suggested add-on repair operations based on service compatibility or labor overlap.

17. The system of claim 14, wherein the interface is configured to allow a user affiliated with a service facility to proactively suggest one or more secondary repair operations associated with a selected primary repair operation.
